(19) United States
(12) Patent Application Publication
(10) Pub. No.: US 2012/0143712 A1
(43) Pub. Date: Jun. 7, 2012

(54) SECONDARY PURCHASE METHOD FOR ONLINE AUCTION OVER A COMMUNICATIONS NETWORK

(76) Inventor: Andres Zuniga Echavarria, Hialeah, FL (US)

(21) Appl. No.: 13/310,795

(22) Filed: Dec. 4, 2011

Related U.S. Application Data
(60) Provisional application No. 61/419,816, filed on Dec. 4, 2010.

(51) Int. Cl. G06Q 30/08

(52) U.S. Cl. 705/26.3

(57) ABSTRACT

A method on a server for providing a secondary purchase method for an auction provided over a communications network, includes: providing an online auction for a seller's item to a plurality of bidders, wherein each of the plurality of bidders provides a bid for the item; selecting a winner of the auction from the plurality of bidders; sending a communication offering the item for a first amount greater than an amount of the winner's bid; receiving payment for the item from a recipient of the communication, wherein payment is for the first amount; sending the seller of the item a payment substantially equal to the winner's bid; sending the winner a payment substantially equal to a difference between the first amount and the winner's bid; and sending a communication to the seller of the item with instructions to send the item to the recipient that paid the first amount.

### CROSS-REFERENCE TO RELATED APPLICATIONS

This patent application claims priority to provisional patent application 61/419,816 titled “Secondary Purchase Method for Online Auction Over a Communications network” and filed Dec. 4, 2010. The subject matter of provisional patent application 61/419,816 is incorporated herein in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The present invention relates to the field of e-commerce and, more specifically, the present invention relates to the field of electronic auctions offered over a communications network.

### BACKGROUND OF THE INVENTION

Online auctions have enjoyed increasing popularity since the 1990s. Using an auction format to sell an item, as opposed to a fixed price sales regime, has the advantage of quickly being able to establish a reliable equilibrium between the supply of an item, the demand for that item and the price of the item. It allows the seller to avoid having to predetermine (often arbitrarily) a price to ask for an item that he wants to sell, and usually results in faster sales. With the advent of the Internet, conducting an auction in an online setting has greatly expanded the scope of auctions. Conducting an auction over the Internet has the potential to greatly expand the number of potential purchasers for an auctioned item because the pool of potential bidders for an online auction is exponentially larger than it ever could have been with traditional live auctions. Online auctions also allow an enormously expanded range of products to be offered for sale to any particular buyer because of the potentially exponentially larger pool of sellers. This results in the opportunity to find, on the one hand, the best price in the world for common items, as well as on the other hand the opportunity to find for sale items which may be unique or extremely rare in the world.

Problems, however, arise in translating the traditional live auction format to the Internet environment. For example, it is common for a bidder to lose an auction because he was not available at the time of completion of the auction, resulting in being outbid by another user. Once the auction is completed, there is no mechanism available for a losing bidder to purchase the auctioned item from the highest bidder, even if the losing bidder is willing to pay more for the item. This results in a loss of at least a portion of the fair market value of an item.

Therefore, what is needed is a system and method for improving the problems with the prior art, and more particularly for a more efficient method and system for allowing secondary purchase of an auctioned item over a communications network.

### BRIEF SUMMARY OF THE INVENTION

Embodiments of the present invention address deficiencies of the art in respect to e-commerce and provide a novel and non-obvious method and system for providing a secondary purchase system for an online auction. In an embodiment of the invention, a method on a server for providing a secondary purchase method for an auction provided over a communications network, includes: providing an online auction for a seller's item to a plurality of bidders over the communications network, wherein each of the plurality of bidders provides a bid for the item; selecting a winner of the auction from the plurality of bidders; sending a communication to a subset of the plurality of bidders, wherein the communication offers the item for a first amount greater than an amount of the winner's bid; receiving payment for the item from a recipient of the communication, wherein payment is for the first amount; sending the seller of the item a payment substantially equal to the winner's bid; sending the winner a payment substantially equal to a difference between the first amount and the winner's bid; and sending a communication to the seller of the item with instructions to send the item to the recipient that paid the first amount.

In another embodiment of the invention, a web-accessible server for providing a secondary purchase method for an auction provided over a communications network comprises one or more processors configured for: providing an online auction for a seller's item to a plurality of bidders over the communications network, wherein each of the plurality of bidders provides a bid for the item; selecting a winner of the auction from the plurality of bidders; sending a communication to a subset of the plurality of bidders, wherein the communication offers the item for a first amount greater than an amount of the winner's bid; receiving payment for the item from a recipient of the communication, wherein payment is for the first amount; sending the seller of the item a payment substantially equal to the winner's bid; sending the winner a payment substantially equal to a difference between the first amount and the winner's bid; and sending a communication to the seller of the item with instructions to send the item to the recipient that paid the first amount.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for managing the online auction and secondary purchase method over a communications network, in accordance with one embodiment of the present invention.

FIG. 2 is a flow chart illustrating a process for managing an online auction and secondary purchase method over a communications network, in accordance with one embodiment of the present invention.

### DETAILED DESCRIPTION OF THE INVENTION

The present invention improves upon the problems with the prior art by providing a more effective online auction system provided over a communications network such as the Internet. The present invention allows for the full fair market value of items to be realized in an online auction scenario by allowing for a secondary purchase process to occur. By allowing losing bidders to purchase the auctioned item at the price they are willing to pay, the market is allowed to bear the full market value of the auctioned item. This reduces or eliminates the case where an auctioned item does not realize its full price because the auction ended too early or all bidders were not around at the time of completion of the auction.

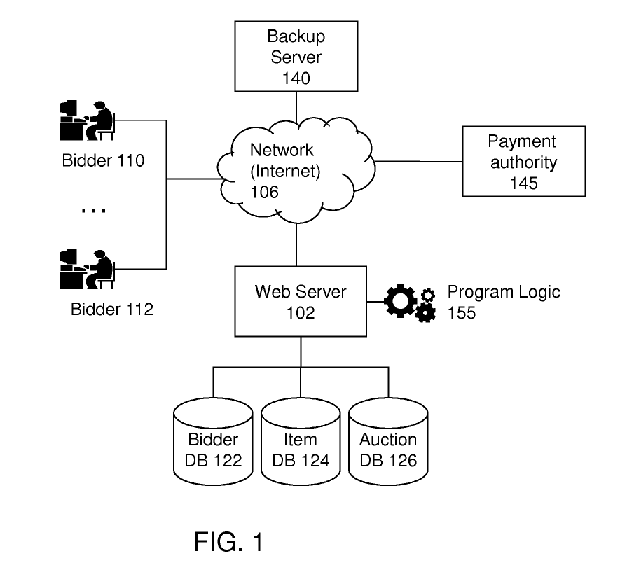

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein bidders, or users, 110-112, each comprising a user and a computer, interact with web server 102 over a network 106, which can be a packet switched communications network such as the Internet and the World Wide Web. The computer of bidders 110-112 can be a desktop, a laptop, handheld computer, a smart phone, a tablet computer or the like.

Web server 102 includes a software engine that delivers applications, such as online auction services, and other data to bidders 110-112. It should be noted that although FIG. 1 shows only two bidders 110-112 and one web server 102, the system of the present invention supports any number of client users and web servers connected via network 106.

Server 102 includes program logic 155 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 155 may reside on a client computer, the server 102 or any combination of the two.

In one embodiment of the present invention, the applications provided by the web server 102 of FIG. 1 (i.e., program logic 155) may be client-server applications having a client portion that resides on client computers 110-112 and a server portion that resides on web server 102. For example, an application can be a web interface that is accessed by bidders 110-112 via network 106. In another embodiment of the present invention, the web server 102 delivers to bidders 110-112 an application having only a client portion that resides on each client computer. For example, the application can be a web browser extension or web browser add-on, which is an installable enhancement to a web browser. The web browser extension or web browser add-on may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

FIG. 1 further shows that web server 102 is connected to a bidder record database 122, an auction item or sale item database 124 and an auction database 126. Database 122 is used to store user or bidder records, such as profiles, images, purchase data, unique identifiers, wish-lists and user account data, which have been created for each bidder 110-112. Item database 124 stores data about items that are being auctioned, such as descriptions, unique identifiers, images, bidder identifiers, auction identifiers, prices, etc. Database 126 stores all other data related to the execution of each auction, such as who participated as a bidder, each bidder's price, each bidder's highest price, etc.

FIG. 1 also shows a payment authority 145 to effectuate payments by bidders for the auction services of server 102. In one embodiment of the present invention, the payment authority 145 is a payment gateway, which is an e-commerce Application Service Provider (ASP) service that authorizes payments for e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc. and effectuates the transfer of funds from the payer to the vendor's account, such as a merchant account.

Lastly, FIG. 1 shows a backup server 140 which makes copies of data on server 102 and/or its associated databases, so that these additional copies may be used to restore the original after a data loss event. The backup server 140 may be used to restore a state following a disaster or to restore small numbers of files after they have been accidentally deleted or corrupted.

Note that although server 102 is shown as a single and independent entity, in one embodiment of the present invention, the functions of server 102 may be integrated with the functions of another entity, such as entities 140, 145 of FIG. 1. Further server 102 and its functionality, according to a preferred embodiment of the present invention, can be realized in a centralized fashion in one computer system, or in a distributed fashion where different elements are spread across several interconnected computer systems.

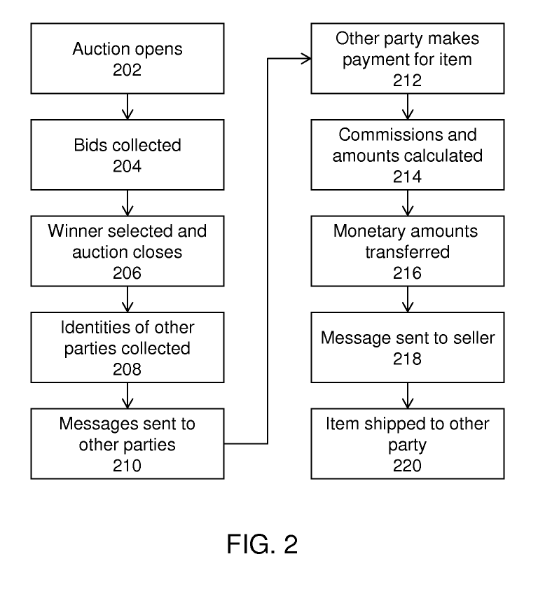

FIG. 2 is a flow chart illustrating a process for managing an online auction and secondary purchase method over a communications network, in accordance with one embodiment of the present invention. The following will describe the control flow that occurs when an online auction and secondary purchase method is performed over a communications network, in accordance with one embodiment of the present invention. Actions performed by server 102 are assumed to be performed, in whole or in part, by program logic 155.

First, in step 202, an online auction is provided for an item to a plurality of bidders 110-112 over the communications network 106. In this step, a seller posts an item for sale in an online auction marketplace and the auction process beings. In step 204 bids are collected from the plurality of bidders 110-112. Next, in step 206, a winner of the auction is selected, such as based on the highest bid. Though there are other known methods in the art for choosing winning bidder.

In step 208, the server 102 collects the identities and/or contact information (such as email address, phone number, etc.) for those parties that may be interested in purchasing the item. This may include the losing bidders that bid in the auction of step 202, those individuals that bid for the same item in a different auction, those individuals that indicated they desire to own the item in a wish-list or other online profile, file, or the like. The identities and/or contact information for those parties that may be interested in purchasing the item may be collected by reading the data in databases 122, 124 and 126.

Subsequently, in step 210, a communication, such as an email, text or voicemail, is sent to those parties identified in step 208, wherein the communication offers the item for a second amount greater than the winning bid. The second amount can be determined by the highest bidder, logic 155 of server 102 or any combination of the two. Then, in step 212, payment is received for the item from one of the individuals who received the communication, wherein payment is for the second amount. Payment may be made via the payment authority 145.

In step 214, commissions and amounts are calculated. The original seller may receive the amount of the highest bid of the first auction of step 202 and the winning bidder of the second purchase of step 212 may receive the difference between the second amount and the amount of the highest bid. The server 102 may retain as a commission a percentage of the second amount, a percentage of the highest bid, a percentage of the difference between the highest bid and the second amount or any combination of the above.

In step 216, payment is then sent to: 1) the seller for an amount substantially equal to the highest bid, and 2) the highest bidder for an amount substantially equal to the difference between the highest bid and the second amount. In step 218, a communication is sent to the original seller of the item with instructions to send the item to the individual that paid the second amount in step 212. In step 220, the original seller of the item sends the item to the individual that paid the second amount in step 212.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for providing a secondary purchase method for an auction provided over a communications network, comprising:
providing an online auction for a seller's item to a plurality of bidders over the communications network, wherein each of the plurality of bidders provides a bid for the item;
selecting a winner of the auction from the plurality of bidders;
sending a communication to a subset of the plurality of bidders, wherein the communication offers the item for a first amount greater than an amount of the winner's bid;
receiving payment for the item from a recipient of the communication, wherein payment is for the first amount;
sending the seller of the item a payment substantially equal to the winner's bid;
sending the winner a payment substantially equal to a difference between the first amount and the winner's bid; and
sending a communication to the seller of the item with instructions to send the item to the recipient that paid the first amount.

2. The method of claim 1, wherein the step of selecting a winner comprises selecting a bidder from the plurality of bidders that provided a highest bid for the item.

3. The method of claim 2, wherein the step of sending a communication comprises sending an email, a text message or a voicemail.

4. The method of claim 3, wherein the step of sending a communication additionally comprises sending a communication to one or more bidders that participated in another item for the same item.

5. The method of claim 4, wherein the step of sending a communication additionally comprises sending a communication to one or more individuals that expressed an interest in owning the item.

6. The method of claim 5, wherein the first amount is determined by the recipient.

7. The method of claim 5, wherein the first amount is determined by a program executing on the server.

8. The method of claim 5, wherein the step of receiving payment includes receiving payment at a merchant account via a payment gateway.

9. The method of claim 8, further comprising retaining as a commission a percentage of the payment of the first amount.

10. The method of claim 8, further comprising retaining as a commission a percentage of the payment made to the seller.

11. The method of claim 8, further comprising retaining as a commission a percentage of the payment made to the winner.

12. A web-accessible server for providing a secondary purchase method for an auction provided over a communications network, comprising one or more processors configured for:
providing an online auction for a seller's item to a plurality of bidders over the communications network, wherein each of the plurality of bidders provides a bid for the item;
selecting a winner of the auction from the plurality of bidders;
sending a communication to a subset of the plurality of bidders, wherein the communication offers the item for a first amount greater than an amount of the winner's bid;
receiving payment for the item from a recipient of the communication, wherein payment is for the first amount;
sending the seller of the item a payment substantially equal to the winner's bid;
sending the winner a payment substantially equal to a difference between the first amount and the winner's bid; and
sending a communication to the seller of the item with instructions to send the item to the recipient that paid the first amount.

13. The server of claim 12, wherein the step of selecting a winner comprises selecting a bidder from the plurality of bidders that provided a highest bid for the item.

14. The server of claim 13, wherein the step of sending a communication comprises sending an email, a text message or a voicemail.

15. The server of claim 14, wherein the step of sending a communication additionally comprises sending a communication to one or more bidders that participated in another item for the same item.

16. The server of claim 15, wherein the step of sending a communication additionally comprises sending a communication to one or more individuals that expressed an interest in owning the item.

17. The server of claim 16, wherein the first amount is determined by the recipient.

18. The server of claim 16, wherein the first amount is determined by a program executing on the server.

19. The server of claim 16, wherein the step of receiving payment includes receiving payment at a merchant account via a payment gateway.

20. The server of claim 19, further comprising retaining as a commission a percentage of the payment of the first amount.
